(19) United States
(12) Patent Application Publication
(10) Pub. No.: US 2005/0097734 A1
(43) Pub. Date: May 12, 2005

(54) Device and method for widening shieldings

(75) Inventors: Martin Stocker, Kussnacht (CH); Brian S. Micciche, Wrightsville, PA (US); David J. Beyer, Lancaster, PA (US)

Correspondence Address: VENABLE, BAETJER, HOWARD AND CIVILETTI, LLP, P.O. BOX 34385, WASHINGTON, DC, 20043-9998, US

(73) Assignee: Komax Holding AG, Dierikon (CH)

(21) Appl. No.: 10/958,993

(22) Filed: Oct. 6, 2004

(30) Foreign Application Priority Data
Oct. 7, 2003 (EP) 03022452.1-1231

(51) Int. Cl. H01B 7/29; B23P 19/00

(52) U.S. Cl. 29/828; 29/745

(57) ABSTRACT

In order to be able to process a coaxial cable (12), it is proposed that the insulated end (10) of the cable (12) is inserted in a groove (20) of a rotating cylinder (30) and the cylinder (30) is turned and thus the shielding (16) and at any event a metal foil (17) located inside the shielding is widened carefully so that a sleeve or similar can be pushed between this and the conductor (14).

### FIELD OF THE INVENTION

The present invention relates to a device for widening shieldings, especially wire-netting-like shieldings of coaxial cables. The invention further relates to a method for widening such shieldings.

### BACKGROUND OF THE INVENTION

### DISCUSSION OF THE PRIOR ART

During the manufacture of cables, e.g. shielded coaxial cables, a special step is required, namely the widening of mainly wire-netting-like shieldings, wherein these shieldings possibly have a metal foil lying within. Usually, the actual conductor lies inside the wire-netting-like shielding or in the unit made of wire-netting-like shielding and metal foil which itself also serves as shielding.

A sleeve is then pushed on into the widened shielding—possibly with the interior metal foil—which then receive the dielectric and the insulated conductor lying within. This sleeve primarily serves to prevent any damage to the inner conductor and the dielectric during the subsequent processing but also to facilitate the further processing. The protective function of the sleeve is primarily required during further processing of a plug, e.g. crimping. The sleeve can be used as a single part or alternatively it can also be constructed as an integral component of the plug or as connectable to the plug.

A considerable number of methods and relevant devices are known for widening the shieldings, wherein these methods are mostly based on the insertion of a knife-like round sleeve, as in EP 1 054 494 A2, for example. A similar method is known from U.S. Pat. No. 3,721,138.

A similar device is proposed in DE 40 27 904 A1, wherein it is provided there to turn the widened screening back on itself. In DE 30 42 825 A1 it is proposed to push the shielding backwards almost in an umbrella fashion.

All these methods and the relevant devices, however, have proved disadvantageous in a certain way, namely first because of the reliability of the process and the necessary careful treatment of the end of the shielding and on the other hand because of a high precision expenditure, in any case in the event of some to some extent careful treatment.

### OBJECT OF THE INVENTION

It is thus the object of the invention to propose a device with which the shielding of a coaxial cable, for example, can be widened for processing, e.g. for soldering-on connections and especially for crimping, to such an extent that a sleeve can be pushed into the shielding, possibly including a metal foil located in the shielding but around the cable(s) with its dielectric enclosed by the shielding. In this case, if possible, it should be possible to dispense with solutions which use a knife pushed in between these parts.

### SUMMARY OF THE INVENTION

The invention solves the object by a device for widening an especially wire-netting-type shielding of a coaxial conductor comprising rotatable mandrel or cylinder and a rotational device for rotating the mandrel or cylinder, wherein the mandrel or cylinder has a substantially rotationally symmetrical front surface and a radially arranged groove is constructed in said front surface. In this case, the measures of the invention first have the consequence that the shielding of the cable can be widened in a simple and careful fashion without any need to fear damage to the shielding or the metal foil as a result of such knife-like devices.

In the basic version of the invention with a cylindrical mandrel, the end exposed at the tip of the outer jacket, the shielding and at any rate the dielectric—if the conductor has no individual strands, can be inserted into the groove formed on the front of the mandrel. The motor brings about a turn of the mandrel. In this case, the cable end widens the shielding further exposed by the outer jacket and possibly, the metal foil, protecting itself, so that a sleeve can then be pushed on.

It has surprisingly been found that the cable end, that is of the conductor or conductors with their dielectric or their dielectrics, simply and easily bends back after the rotation according to the present invention, at least so far that the sleeve can be pushed onto the cable end.

Especially advantageous as the front of the device are either flat or substantially flat arrangements of the mandrel or cylinder or however, indented, especially funnel-shaped indented arrangements of the front which then support the threading into the groove.

Especially advantageous is a method for widening an especially wire-netting-like shielding of a coaxial conductor, wherein the end of the coaxial conductor has a region in which the outer insulation is removed, a further region facing the cable end in which, in addition to the outer insulation, the shielding or the shielding and a metal foil arranged inside the shielding is removed, comprising the steps inserting the front end of the coaxial cable, preferably of the conductor or conductors arranged in the shielding into a groove constructed on the front side of a mandrel or cylinder and rotating said mandrel or cylinder to widen the shielding.

Further advantageous details of the invention are put forward in the dependent claims.

The aforesaid elements to be used according to the invention as well as those claimed and described in the following exemplary embodiments are not subject to any particular exclusion conditions in their size, design, material usage and technical conception so that the selection criteria known in the respective field of application can be used without limitation.

Further details, features and advantages of the subject matter of the invention are obtained from the following description of the relevant drawings in which, for example, a device and a relevant process sequence for the present invention is explained.

### BRIEF DESCRIPTION OF THE DRAWINGS

In the figures:

FIG. 1 is a diagram of a first embodiment of the device according to the present invention before inserting the cable end into the groove;

FIG. 2 is a diagram of the embodiment of the device according to FIG. 1 after inserting the cable end into the groove during the widening process;

FIG. 3 is a diagram of the end of the coaxial conductor when this is prepared for the process for the present invention;

FIG. 4 is a diagram of the end of the coaxial conductor after treatment with the device according to the present invention, that is after executing the essential steps of the method according to the invention;

FIG. 5 is a diagram of the end of the coaxial conductor after inserting a sleeve into the widened shielding or onto the interior conductor;

FIG. 6 is a perspective view of the cylindrical mandrel with the groove according to FIG. 1;

FIG. 7 is a perspective view of a second embodiment of the device according to the present invention;

FIG. 8 is a side view according to FIG. 7; and

FIG. 9 is a sectional drawing according to FIG. 8.

### DESCRIPTION OF THE EMBODIMENTS

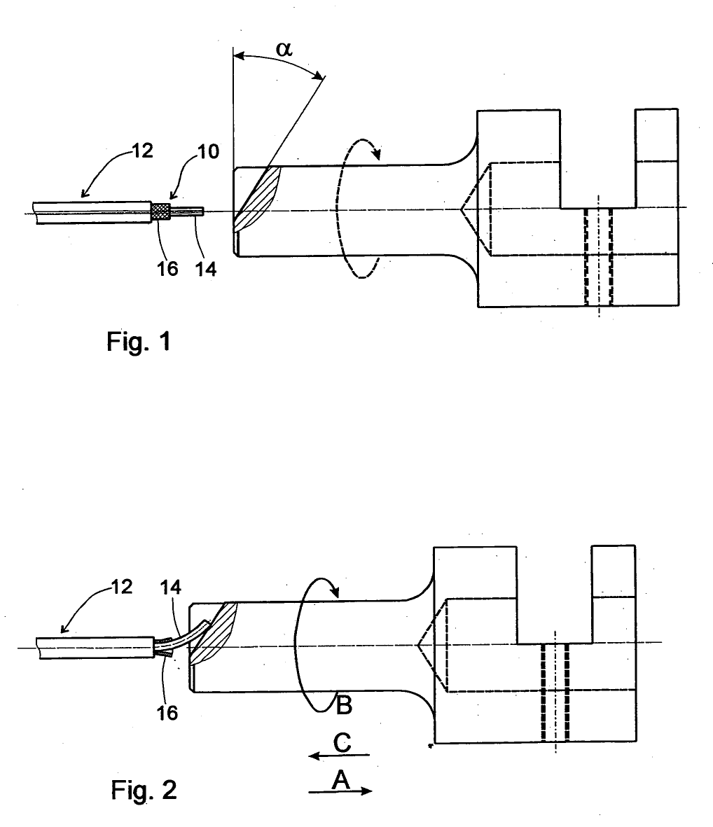

In FIG. 1 the device as a whole is shown from the side together with the prepared cable end 10 of a coaxial cable 12. The groove 20 let into the front area of the cylinder 30, into which the conductor 14 of the cable end 10 can be inserted, in the present exemplary embodiment by linear movement of the entire cylinder, is shown schematically. During the process the cable end is held in its non-insulated region by a gripping device. FIG. 2 then shows the cable end 10 when inserted into the groove 20 (movement A). In this case, the cylinder 30 is turned by a motor (movement B) whereby the conductor 14 of the cable end 10 widens the shielding and possibly a metal foil 17 arranged between the shielding 16 (outside) and the conductor 14 (inside) in a funnel shape. In the present exemplary embodiment the conductor 14 is constructed as a metal strand with a dielectric surrounding this, as is usual in coaxial cables of simple type. After the widening, the cylinder is moved linearly back again into the starting position by turning (movement C) whereby the conductor 14 of the cable end 10 is brought almost completely back into its starting position.

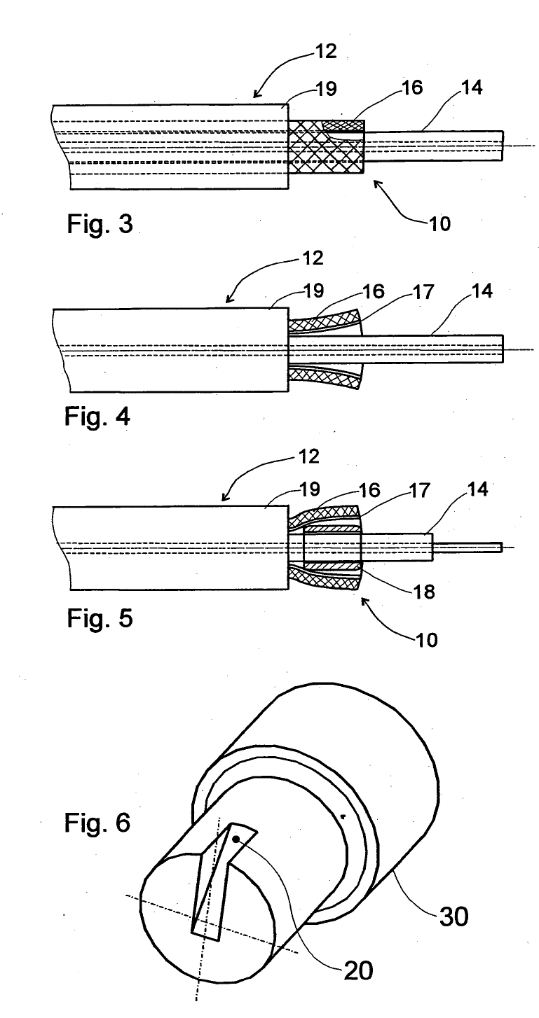

FIG. 3 again shows in detail the initial situation of the cable end 10 with the insulated shielding 16 and the conductor 14. FIG. 4 shows the cable end 10 with the widened shielding 16, the metal foil 17 and a prepared sleeve 18 for pushing onto the conductor 14. In FIG. 5 the sleeve 18 is pushed onto the conductor 14 and under the shielding 16 whereby the process is ended and, in the sense of the present invention, the cable end 10 is prepared for further processing.

FIG. 6 shows the front end of the cylinder 30 with the groove 20 let into it. In this exemplary embodiment the groove 20 extends from the edge of the cylinder 30 on the front over the centre and has a width somewhat larger than that of the conductor 14 (including the insulation of the conductor) of the cable end 10. The groove 20 is inclined at an angle of about 30° with respect to the front of the cylinder 30 and ends on the other side of the centre at an edge 22.

In order to be able to process conductor ends having different thicknesses as well as cables with a plurality of conductors arranged in a shielding, the cylinder 30 of the device is constructed as exchangeable so that an optimal cylinder can be used for each configuration. The cylinder 30 in the present exemplary embodiment is constructed as a unit which can be positioned on a clamping device 40 fitted with a rotary motor and locked.

It will become clear to the person skilled in the art that the arrangement of the groove 20 on the front of the mandrel or cylinder can be undertaken in a fashion other than that described here, e.g., the groove 20 need not necessarily extend to the edge of the cylinder but can end inside the cylinder. Furthermore, the central point of the cylinder 30 need not necessarily be aligned onto the cable end but can also be parallel offset by a small amount and/or point in a direction other than the cylinder axis. Furthermore, the groove can also have a non-straight e.g. a rounded rear side in order to achieve better guidance of the cable end into the groove 20.

Furthermore, it will also be clear to the person skilled in the art that other embodiments can have the same effect. In this case, special mention may be made of that embodiment in which the linear movement is executed by the gripping device which holds the cable. In this embodiment the mandrel does not execute any linear movement but turns in a stationary position. Another embodiment is also possible wherein both the gripping device which holds the cable and the mandrel execute a linear movement.

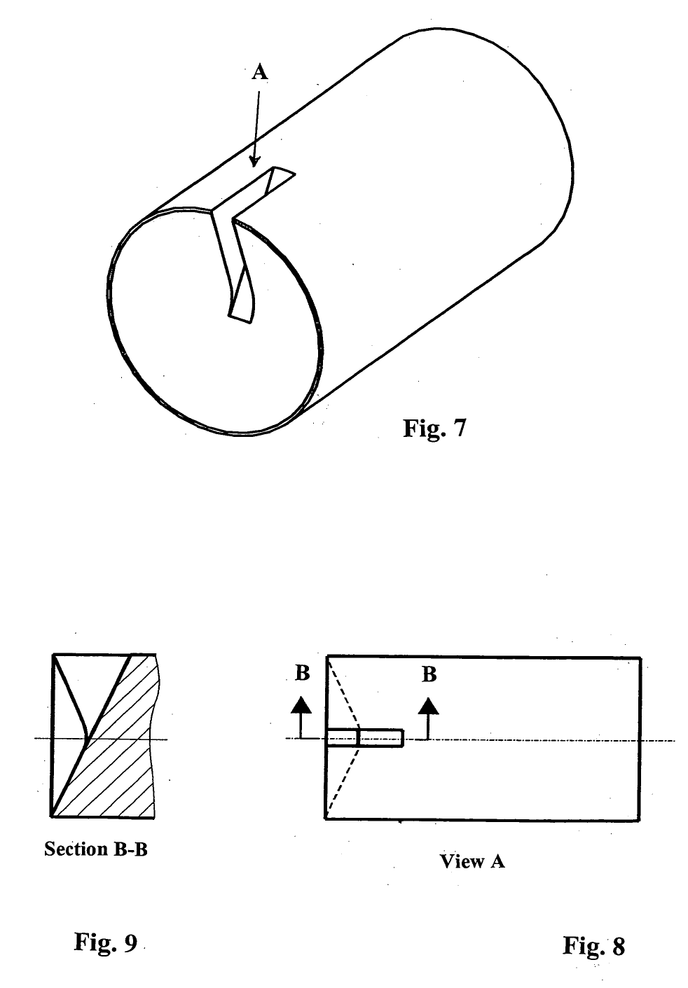

In a second, preferred embodiment according to FIGS. 5 to 7, the front of the cylindrical rotational element is constructed as indented in a funnel shape, in the exemplary embodiment therefore as approximately conical. Alternatively however, other surface functions such as a spherical section or a hyperbolic, logarithmic or parabolic indentation are also feasible. With this indentation in this exemplary embodiment the insertion of the cable end into the groove is assisted and facilitated by the funnel shape.

1. A device for widening an especially wire-netting-type shielding of a coaxial conductor comprising
rotatable mandrel or cylinder and
a rotational device for rotating the mandrel or cylinder, wherein
the mandrel or cylinder has a substantially rotationally symmetrical front surface and
a radially arranged groove is constructed in said front surface.

2. The device according to claim 1, wherein said front surface is not constructed as elevated.

3. The device according to claim 1, wherein said front surface is constructed as substantially parallel to the plane of rotation.

4. The device according to claim 1, wherein said front surface is constructed as indented (concave).

5. The device according to claim 4, wherein said front surface is constructed as indented in a substantially conical shape.

6. The device according to claim 4, wherein said front surface is constructed as indented in a substantially spherical-segment, hyperbolic or parabolic shape.

7. The device for widening an especially wire-netting-like shielding of a coaxial conductor according to claim 1, wherein said groove extends over the centre of said mandrel or cylinder.

8. The device for widening an especially wire-netting-like shielding of a coaxial conductor according to claim 1, wherein said groove extends as far as the outer surface of said mandrel or cylinder.

9. The device for widening an especially wire-netting-like shielding of a coaxial conductor according to claim 1, wherein said groove is constructed as inclined to the front surface of the mandrel or cylinder.

10. The device for widening an especially wire-netting-like shielding of a coaxial conductor according to claim 9, wherein said groove has an angle α of 10° to 60°, preferably 30° to 40° with respect to the front surface of said mandrel or cylinder.

11. A method for widening an especially wire-netting-like shielding of a coaxial conductor, wherein the end of the coaxial conductor has a region in which the outer insulation is removed, a further region facing the cable end in which, in addition to the outer insulation, the shielding or the shielding and a metal foil arranged inside the shielding is removed, comprising the steps
inserting the front end of the coaxial cable, preferably of the conductor or conductors arranged in the shielding into a groove constructed on the front side of a mandrel or cylinder and
rotating said mandrel or cylinder to widen the shielding.

12. The method according to claim 11, wherein the end of the coaxial conductor is held by a gripping device at its non-insulated part.

13. The method according to claim 11, wherein the insertion of the front end of the coaxial cable is brought about by an axial shift of the mandrel.

14. The method according to claim 12, wherein the insertion of the front end of the coaxial cable is brought about by an axial shift of the gripping device.

15. The method according to claim 11, wherein the cable end is inserted over half of the groove.

16. A method for processing a cable end of a coaxial conductor in which after executing the steps according to claim 11, a sleeve is pushed under the widened part of the shielding.
